(19) United States
(12) Patent Application Publication
(10) Pub. No.: US 2008/0150934 A1
(43) Pub. Date: Jun. 26, 2008

(54) Image display device

(76) Inventors: Toshifumi Ozaki, Koganei (JP); Masahisa Tsukahara, Fujisawa (JP); Fumio Haruna, Yokohama (JP); Junichi Yokoyama, Fujisawa (JP); Toshimitsu Watanabe, Yokohama (JP)

Correspondence Address: MILBANK, TWEED, HADLEY & MCCLOY, 1 CHASE MANHATTAN PLAZA, NEW YORK, NY, 10005-1413, US

(21) Appl. No.: 11/986,956

(22) Filed: Nov. 27, 2007

(30) Foreign Application Priority Data
Dec. 1, 2006 (JP) 2006-325685
Dec. 1, 2006 (JP) 2006-325728

(51) Int. Cl. G09G 5/10; G09G 3/22

(52) U.S. Cl. 345/214; 345/75.2

(57) ABSTRACT

A current detection data is acquired by a scanning line current detection resistance, an adder-subtracter and an A/D converter. the current detection data is inputted to a voltage correction circuit, the voltage correction circuit output a correction signal. Using the correction signal, a scanning electrode voltage correction circuit performs the correction of the scanning selection voltage. Further, the voltage correction circuit generates data electrode drive data based on the current detection data and image data and inputs the data electrode drive data to a data electrode drive circuit. the present invention prevent a change of brightness and of smear with time.

### CROSS-REFERENCE TO RELATED APPLICATION

The present application claims priority from Japanese application JP2006-325728 filed on Dec. 1, 2006, and Japanese application JP2006-325685 filed on Dec. 1, 2006, the content of which is hereby incorporated by reference into this application

### BACKGROUND OF THE INVENTION

1. Field of the Invention

The present invention relates to an image display device which arranges electron emitting elements thereon in a matrix array.

2. Background Art

Recently, a self-luminous matrix-type display has been attracting attentions. The self-luminous matrix-type display is configured such that electron emitting elements are arranged on crossing points of lines which intersect each other at a right angle, applied voltages or voltage applied times for respective electron emitting elements are modulated so as to control emission quantities of electrons from electron emitting elements, emitted electrons are accelerated by applying a high voltage to the emitted electrons, and the accelerated emitted electrons are radiated to the phosphors. This kind of display is generally called a field emission display (Hereafter, it is said “FED”).

The electron emitting elements which are used in this type of display are classified into metal/insulation film/metal type electron emitting elements, field-emission-type electron emitting elements, surface-conductive-type electron emitting elements, carbon-nano-tube and the like.

A display panel which uses the electron emitting elements is constituted of a back substrate on which the plurality of electron emitting elements are arranged in a matrix array and lines for driving these electron emitting elements are mounted, and a face substrate to which the phosphors are applied by coating.

FIG. 8 is a schematic view of the back substrate of the display panel. In FIG. 8, numeral 201 indicates the electron emitting elements which constitute respective pixels. The electron emitting element 201 is arranged at a crossing point of a data line 202 in the vertical direction and a scanning line 203 in the horizontal direction, and is connected to the respective lines. Symbols D1 to Dm indicate data electrodes which apply data signals to the respective data lines 201, and symbols S1 to Sn indicate scanning electrodes which apply scanning selection voltages and scanning non-selection voltages to the respective scanning lines 203.

FIG. 9 is a Log (I)-V characteristic graph of an applied voltage V to the electron emitting element 201 and an element current I which flows into the electron emitting element (logarithmic axis). In FIG. 9, the element current I which flows in response to the applied voltage V is increased exponentially. The characteristic of the element current I which flows into the electron emitting element in response to the applied voltage V to the electron emitting element can be approximately expressed by a threshold voltage Vth when the element current I assumes a predetermined threshold current Ith and the gradient a of the element current I with respect to the applied voltage V.

FIG. 19 is the relation between applied voltage V and flowing current I in the electron source when the thin film electron source is used as an emission element for the display panel. When applied voltage V is in the low voltage region (V<threshold voltage Vth), current I of the thin film electron source is very small. The current begins to flow to the thin film electron source when applied voltage exceeds threshold (Vth). The number of currents increases in exponential compared with applied voltage V.

FIG. 10 is a drive circuit for driving the display panel which uses the electron emitting elements. Here, the explanation is made with respect to a case in which an electric current flows into the electron emitting element when a voltage of the scanning line assumes a voltage higher than a voltage of the data line.

Timing controller 205 generates control signal 214 which controls scanning electrode select circuit 30 and outputs it. In FIG. 10, an image signal 210 and a synchronizing signal 204 are inputted to a timing controller 205. The timing controller 205 generates a control signal 208 which controls data electrode drive circuit 7, and image data 207. Timing controller 205 generates control signal 214 which controls scanning electrode select circuit 30 and outputs it.

The data electrode drive circuit 7 outputs a data voltage to the data electrodes D1 to Dm formed on the back substrate which constitutes the display panel 215. Further, the scanning electrode selection circuit 30 outputs a scanning selection voltage to one electrode out of the scanning electrodes S1 to Sm formed on the back substrate which constitutes the display panel 215.

Scanning electrode select circuit 30 selects one scanning wiring from among each scanning wiring.

In the scanning electrode selection circuit 30, one scanning selection switch is selected and turned on out of the scanning selection switches SH1 to SHn based on the control signal 214, and the scanning selection voltage from a first reference voltage source 211 is applied to one of the scanning electrodes S1 to Sn of the selected scanning line. Further, a plurality of non-selection switches SL1 to SLn corresponding to the scanning line in a non-selected state is turned on so as to supply a scanning non-selection voltage from a second reference voltage source 212 to the scanning electrodes. FIG. 10 shows a case in which the scanning selection switch SH2 is selected. Here, a high voltage circuit 220 supplies a high voltage to the face substrate of the display panel 215.

FIG. 11 is an operational waveform chart when a line sequential operation is performed by the drive circuit shown in FIG. 10. In FIG. 11, for example, a signal VSH1 is a control signal for the scanning selection switch SH1, and the scanning selection switch SH1 is turned on when the signal VSH1 assumes a High level.

Vertical scanning is started with a selection operation from the scanning line connected to the scanning electrode S1. When the signal VSH1 assumes a High level during a period T1, the scanning selection switch SH1 is turned on, and the scanning selection voltage is applied to the first scanning electrode S1. Here, due to an operation of the data electrode drive circuit 7, data voltages Vd11 to Vd1m corresponding to the image data 207 are respectively supplied to the data electrodes D1 to Dm.

Next, when a signal VSH2 assumes a High level during a period T2, the scanning selection switch SH2 is turned on so that the scanning selection voltage is supplied to the second scanning electrode S2. Here, data voltages Vd21 to Vd2m are respectively supplied to the respective data electrodes D1 to Dm. By performing these operations sequentially, image data amounting to 1 field is displayed on the display panel.

The above-mentioned image display device which arranges the electron emitting elements thereon in a matrix array has a drawback that the brightness is changed due to a change of an element current which flows into the back substrate from the face substrate with time. To overcome this drawback, patent document 1 (JP-A-2001-202059) discloses a technique in which an emitted current is detected by a detection resistance connected to a negative pole side of a high voltage circuit, the detected current value is converted into current data by A/D conversion, and an applied voltage to electron emitting elements is controlled such that the current data agrees with a predetermined reference value.

Further, most of element current is not emitted to the face substrate as electrons but flows into the scanning lines. Accordingly, a voltage drop is generated due to a scanning line resistance and an ON resistance of a selection switch of a scanning electrode selection circuit thus deteriorating image quality due to brightness difference called as “smear”. To overcome this drawback, patent document 2 (Japanese Patent No. 3311201 publication) discloses a technique which corrects a data voltage to compensate for voltage drops of respective parts of a scanning line determined in response to image signals.

Further, patent document 3 (JP-A-2004-86130) discloses a technique which drives a display device such that a scanning selection voltage outputted to a scanning electrode is set to a predetermined reference value even when a voltage drop is generated due to an ON resistance of a selection switch of a scanning electrode selection circuit and a current which flows corresponding to an image signal.

patent document 4 (JP-A-H11-354009) discloses a technique which the product of the voltage and the current is calculated, and it makes amends for driving wave to become it as well as the value which the calculation result set beforehand.

### SUMMARY OF THE INVENTION

An emitted current which flows into the back substrate from the face substrate and determines the brightness of the display panel is determined by the multiplication of (1) the element current I which flows into the electron emitting element when an applied voltage V is applied to the electron emitting element (V-I characteristic), (2) a rate of the emitted current which flows corresponding to the element current I (emission efficiency) and (3) Luminous efficiency of phosphor.

It becomes a brightness change on the entire screen and it appears for a change with the lapse of time of element (2) and (3). About element (1), in addition, the brightness difference, which is called a smear, is generated with the lapse of time. The smear is generated by the change in the amount of voltage drop caused by the impedance of the scanning wiring resistance and the scanning electrode select circuit. When detect only the emission current, the brightness of a certain gray scale is brightness of the desire but it does not become the brightness of the desire in other gray scale.

In the method described in patent document 1, when the emission efficiency is deteriorated by a change with time, even when the I-V characteristic is not changed, the applied voltage V is controlled to bring the emitted current to the reference value and hence, the element current I is increased. As a result, an electric current which flows into the scanning line is increased and hence, a voltage drop quantity is increased whereby the deterioration of image quality by smear is worsened.

Further, even when smear can be suppressed at an initial stage using the methods described in patent documents 2, 3, the deterioration of image quality due to smear becomes conspicuous with time. Smear is a phenomenon which can be more apparently detected than the change of brightness over the whole screen and hence, there exists a demand for the suppression of smear.

Further, in patent document 1, an image is displayed due to modulation of a voltage applying time and hence, a specific current value is detected, and an applied voltage is controlled such that the detected specific current value agrees with a reference value. However, according to this method, in displaying the image due to voltage amplitude modulation of a data voltage shown in FIG. 11, when the gradient a of the I-V characteristic shown in FIG. 9 is changed with time, although the change of brightness may not be observed with respect to the image data corresponding to the specific current value, the change of brightness is generated with respect to the image data other than the image data corresponding to the specific current value.

Moreover, it is necessary to set the amount of voltage drop to the change in the V-I characteristic of the electron source again. In other words, the V-I property change shows up in shape of smear on the screen. The smear is a phenomenon recognized more remarkably than the brightness change on the entire screen.

Accordingly, it is an object of the present invention to provide a technique which can, even when electron emitting elements are changed with time, prevent a change of brightness by adopting an element current corresponding to image data and, at the same time, can prevent a change of image quality by smear with time by setting a voltage drop generated by an electric current which flows into scanning lines at a fixed value.

The purpose of this invention is that suppressed the smear generation and picture quality deterioration, even if the V-I characteristic of the electron source causes a change with the lapse of time. Moreover, the purpose of this invention is that the offer of the imager with high reliability.

Due to such a constitution, it is possible to provide an image display device of high reliability which can eliminate the deterioration of image quality. Further, the present invention can also provide an image display device which does not generate a change of brightness attributed to a change with time of the gradient a of I-V characteristic even when an image is displayed due to voltage amplitude modulation.

The present invention is directed to an image display device which includes a display panel having a back substrate which includes a plurality of scanning lines parallel to each other, a plurality of data lines which is orthogonal to the scanning lines and a plurality of electron emitting elements which is connected to crossing points between the scanning lines and the data lines, and a face substrate having phosphors which emit light due to electrons emitted from the electron emitting elements, a scanning electrode selection means which is connected to the scanning lines, a data electrode drive means which is connected to the data lines, and a high voltage means which radiates emission electrons emitted from the electron emitting elements to phosphors after accelerating the emission electrons, wherein the image display device further includes a scanning line current detection means which detects a scanning line current flowing into the scanning lines from the scanning electrode selection means, and a scanning electrode voltage correction means which corrects the scanning line selection voltage which the scanning electrode selection means outputs based on a detection result of the scanning line current detection means such that the scanning line current assumes a predetermined value.

Further, the image display device of the present invention may also include the scanning line current detection means which detects the scanning line current flowing into the scanning lines from the scanning electrode selection means, and a voltage correction means which corrects a data voltage which the data electrode selection means outputs based on detection results of the scanning line current detection means such that an electric current which flows into the electron emitting element correspond to image data.

Further, the present invention is directed to an image display device which includes a display panel having a back substrate which includes a plurality of scanning lines parallel to each other, a plurality of data lines which is orthogonal to the scanning lines and a plurality of electron emitting elements which is connected to crossing points between the scanning lines and the data lines and a face substrate having phosphors which emit light due to electrons emitted from the electron emitting elements; a scanning electrode selection means which is connected to the scanning lines; voltage drop correction means which operates the influence of voltage drop by the current that flows to scanning wiring and data wiring and the resistance, a data electrode drive means which is connected to the data lines; and a high voltage means which radiates emission electrons emitted from the electron emitting elements to the phosphors after accelerating the emission electrons, wherein a current detection means to detect which a first current value flowing to scanning wiring when image pattern of black or low gray scale is displayed in display panel and a second current value flowing to the scanning wiring when the image pattern of other gray scale is displayed, an difference operation means which operate the difference as for the first current value and the second current value, the voltage drop correction means controls the scanning electrode voltage correction means or the data electrode driving means based on the difference operation result.

As described above, according to the present invention, by detecting the scanning line current and by correcting either one or both of the scanning selection voltage and the data voltage, it is possible to acquire the element current corresponding to the image data even when the threshold voltage or the gradient of the electron emitting element are changed with time thus preventing the change of brightness.

Further, a voltage drop generated by an electric current which flows into scanning lines can be also set to a fixed value thus preventing the deterioration of image quality by smear with time. Accordingly, it is possible to provide an image display device of high reliability and high image quality.

In the image display device using a display panel which irradiates the accelerated electron to the phosphor which impresses the high tension like the FED, the present invention is obtain the effect that the picture quality deterioration because of a change with the lapse of time of the display panel is suppressed, and the best image display is enabled.

In a conventional display which arranges electron emitting elements thereon in a matrix array, smear is generated due to a change of electron sources with time or a change of temperature characteristic of the electron sources thus influencing quality of a display image. By applying the present invention to the conventional matrix-array display, a favorable video display can be realized. Further, the present invention is effectively applicable to an image display device which uses cold cathode elements such as a metal/insulation film/metal type image display device, a field-emission-type image display device or a surface-conductive-type image display device.

### BRIEF DESCRIPTION OF THE DRAWINGS

FIG. 1 is a circuit constitutional view of an image display device of an embodiment 1 of the present invention;

FIG. 2A and FIG. 2B are change-with-time graphs of an I-V characteristic of an electron emitting element for explaining the image display device of the embodiment 1;

FIG. 3 is a circuit constitutional view of an image display device of an embodiment 2 of the present invention;

FIG. 4 is a circuit constitutional view of an image display device of an embodiment 3 of the present invention;

FIG. 5 is an operational waveform chart for explaining the image display device of the embodiment 3;

FIG. 6 is an operational waveform chart for explaining the image display device of the embodiment 3;

FIG. 7 is a circuit constitutional view of an image display device of an embodiment 4 of the present invention;

FIG. 8 is a structural model view of a back substrate on which electron emitting elements are arranged in a matrix array;

FIG. 9 is a voltage-current characteristic graph of the electron emitting element;

FIG. 10 is a constitutional view of a drive circuit of a display panel which uses the electron emitting elements; and

FIG. 11 is an operational waveform chart for explaining an operation of the drive circuit shown in FIG. 10;

FIG. 12 is a circuit constitutional view of an image display device of an embodiment 5 of the present invention;

FIG. 13A and FIG. 13B are graphs of electron source characteristic of an electron emitting element for explaining the image display device of the embodiment 5;

FIG. 14 is a circuit constitutional view of an image display device of an embodiment 6 of the present invention;

FIG. 15 is a circuit constitutional view of an image display device of an embodiment 7 of the present invention;

FIG. 16 is a circuit constitutional view of an image display device of an embodiment 8 of the present invention;

FIG. 17 is a circuit constitutional view of an image display device of an embodiment 9 of the present invention;

FIG. 18 is an operational waveform chart for explaining the image display device of the embodiment 9;

FIG. 19 is a voltage-current characteristic graph of the electron emitting element.

### DETAILED DESCRIPTION OF PREFERRED EMBODIMENTS

Hereinafter, embodiments of the present invention are explained in conjunction with drawings.

### Embodiment 1

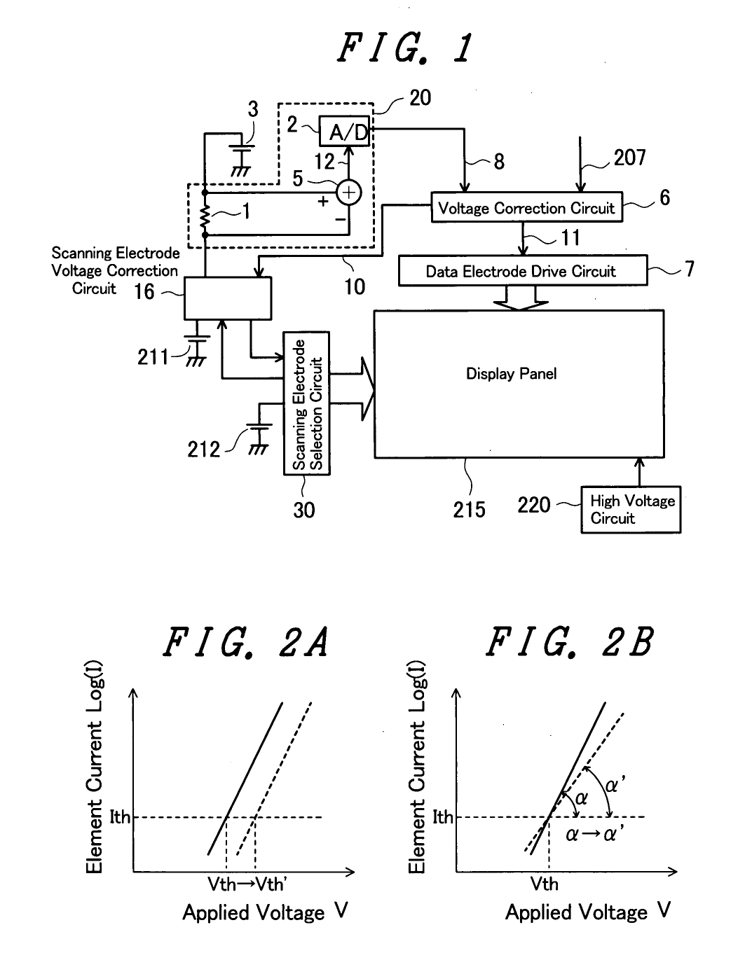

The explanation is made with respect to an image display device according to the present invention in conjunction with FIG. 1, FIG. 2A and FIG. 2B. FIG. 1 is a circuit constitutional view of the image display device of this embodiment. FIG. 2A and FIG. 2B are graphs for explaining a change-with-time of I-V characteristic of an electron emitting element.

In FIG. 1, a power source 3 is provided for supplying electricity to a scanning electrode voltage correction circuit 16. A detection resistance 1 detects a scanning line current which flows into a selected scanning line from the power source 3 via the scanning electrode voltage correction circuit 16 and a scanning electrode selection circuit 30.

An adder-subtracter 5 receives inputting of potentials of both ends of the detection resistance 1, and outputs an output signal 12 proportional to voltage difference between both ends of the detection resistance 1. The output signal 12 is converted into digital current detection data 8 by an analog-digital (A/D) converter 2 and is inputted to a voltage correction circuit 6.

The voltage correction circuit 6 generates a correction signal 10 for correcting an output voltage of the scanning electrode voltage correction circuit 16. The scanning electrode voltage correction circuit 16 corrects a scanning selection voltage outputted from a scanning electrode selection circuit 30 to a predetermined voltage value in response to the correction signal 10.

Further, the voltage correction circuit 6 generates data electrode drive data 11 using image data 207 inputted from a timing controller and the current detection data 8, and inputs the data electrode drive data 11 to a data electrode drive circuit 7.

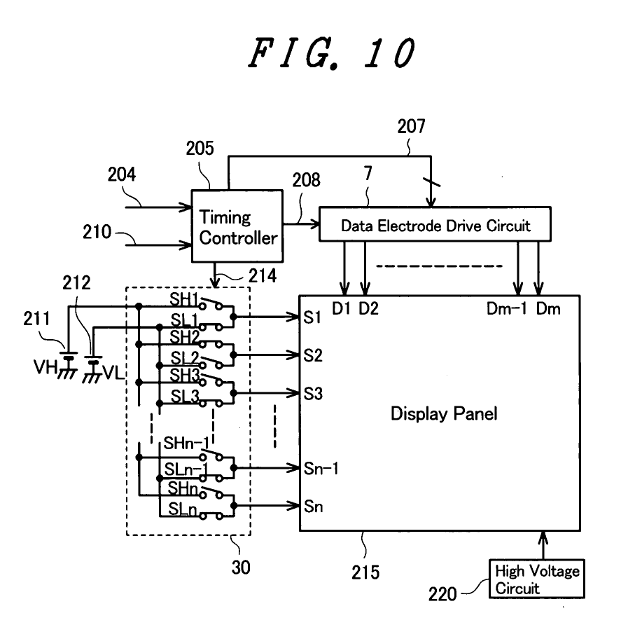

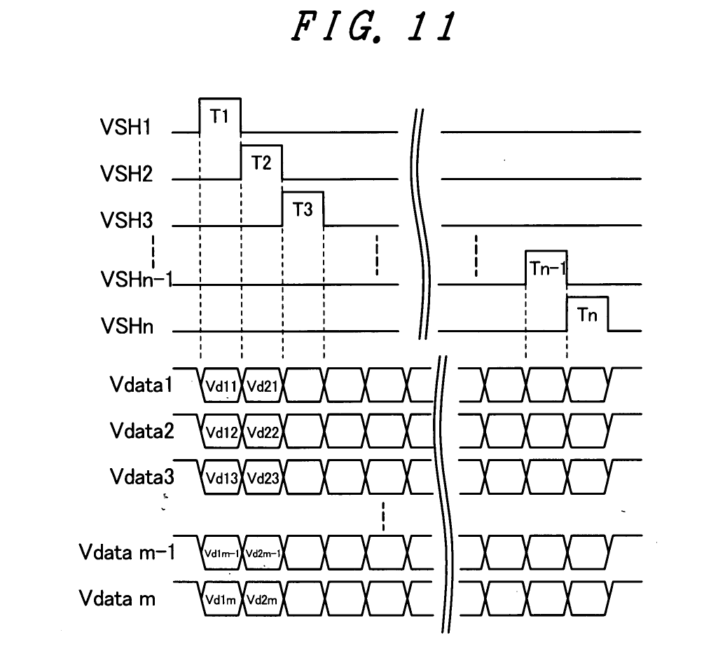

A scanning line current detection circuit 20 is constituted of the detection resistance 1, the A/D converter 2 and the adder-subtracter 5. Parts indicated by numerals 7, 30, 207, 211, 212, 215 and 220 in FIG. 1 respectively have the same functions as the corresponding parts indicated by numerals 7, 30, 207, 211, 212, 215 and 220 in FIG. 10.

FIG. 2A and FIG. 2B are graphs for explaining changes of the electron emitting elements having different I-V characteristics with time. In FIG. 2A, a threshold voltage indicative of a parallel movement of I-V characteristic in the voltage-axis direction is changed to Vth′ from Vth. The scanning selection voltage outputted from the scanning electrode selection circuit 30 is corrected to compensate for such a change of the threshold voltage of the electron emitting element with time.

The manner of correction is explained. In FIG. 1, the image data 207 which allows an applied voltage to be applied to a predetermined number of electron emitting elements to assume a threshold voltage Vth is inputted to the voltage correction circuit 6. The voltage correction circuit 6 compares the current detection data 8 acquired by the scanning line current detection circuit 20 and a scanning line current value acquired by the image data 207 (to be more specific, a value obtained by multiplying the number of electron emitting elements which emit electrons at a threshold current value Ith in the scanning line direction by the threshold current value Ith), and generates the correction signal 10 indicative of an applied voltage Vth′ necessary for setting an element current to the threshold current value Ith. The scanning electrode correction circuit 16 corrects the scanning selection voltage in response to the correction signal 10. Due to such an operation, even when the threshold voltage of the electron emitting element is changed to Vth′ from Vth, the element current of the electron emitting element assumes a fixed threshold current value Ith.

Further, as shown in FIG. 2B, in the electron emitting element, a logarithmic gradient of the electron emission current I with respect to the applied voltage V is changed with time from α to α′. The data voltage is corrected so as to correct such a change of gradient.

The manner of correction is explained. In FIG. 1, the image data 207 which allows the applied voltage to be applied to the electron emitting elements to assume a voltage other than the threshold voltage Vth is sequentially inputted to the voltage correction circuit 6. The voltage correction circuit 6 acquires the gradient α′ based on the current detection data 8 obtained sequentially from the scanning line current detection circuit 20, and generates data electrode drive data 11 which is α/α′ times as large as the image data 207. The data electrode drive circuit 7 outputs a data voltage to the display panel 215 in response to this data electrode drive data 11. Due to such an operation, the data voltage is corrected α/α′ times corresponding to the image data 207 and hence, even when the gradient of the I-V characteristic of the electron emitting element is changed with time, the element current corresponding to the image data 207 is obtained.

Here, when the changes of the electron emitting elements with time shown in FIG. 2A and FIG. 2B exist simultaneously, the scanning selection voltage and the data voltage are simultaneously corrected.

As described above, according to this embodiment, in the display which arranges the electron emitting elements thereon in a matrix array, by detecting the scanning line current and by correcting either one or both of the scanning selection voltage and the data voltage, even when the threshold voltage and the gradient of the electron emitting elements are changed with time, the element current corresponding to the image data can be obtained thus preventing a change of brightness.

Further, by setting a voltage drop attributed to an electric current which flows into the scanning lines to a fixed value, the deterioration of image quality by smear with time can be prevented. Accordingly, it is possible to provide an image display device of high reliability and high image quality.

### Embodiment 2

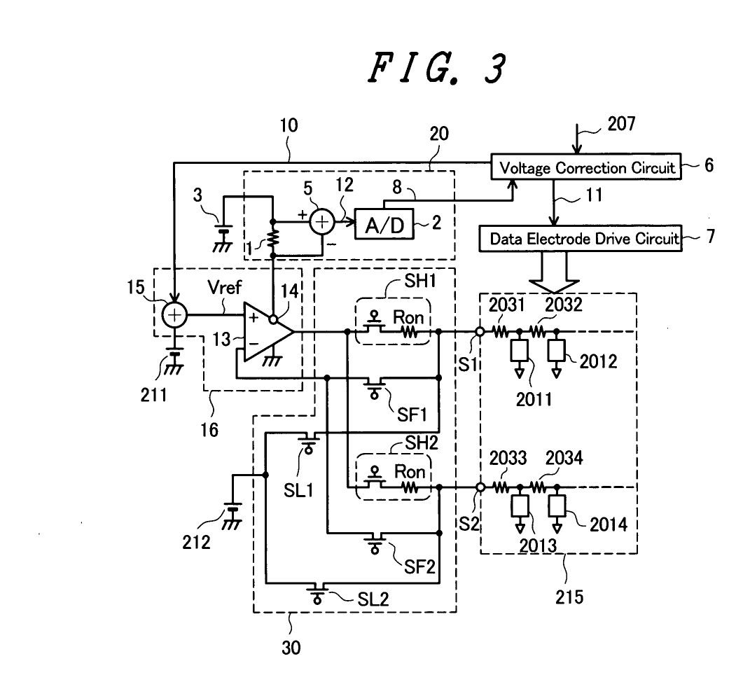

The explanation is made with respect to an image display device according to the embodiment 2 of the present invention in conjunction with FIG. 3. This embodiment is configured such that even when a voltage drop is generated due to an ON resistance Ron of selection switches SH1 (i=1 to n) of a scanning electrode selection circuit 30 and an electric current which flows corresponding to image data 207, at the time of driving the image display device such that a scanning selection voltage outputted to scanning electrodes Si (i=1 to n) assumes a predetermined reference voltage, a reference voltage value which becomes a scanning selection voltage is corrected so as to prevent an element current from being changed even when a threshold voltage is changed with time.

FIG. 3 is a circuit constitutional view of the image display device of this embodiment. For facilitating the explanation of the circuit constitution, only two scanning lines and a circuit for driving the scanning lines are shown in the drawing. In FIG. 3, numerals 2011 to 2014 indicate electron emitting elements in the inside of a display panel 215, and numerals 2031 to 2034 indicate scanning line resistances each of which corresponds to one pixel. The scanning electrode selection circuit 30 includes feedback switches SF1 and SF2 which monitor voltages of the scanning electrodes S1 and S2. The scanning electrode voltage correction circuit 16 is constituted of a negative feedback amplifier 13 and an adder 15.

A voltage of the scanning electrode S1 or S2 is inputted to an inverse-phase input terminal of the negative feedback amplifier 13 via the feedback switch SF1 or SF2. Electricity is supplied to a power source supply terminal 14 of the negative feedback amplifier 13 from a power source 3.

A scanning line current is supplied to the display panel 215 via an output element in the inside of the negative feedback amplifier 13 and a scanning selection switch SH1 or SH2 from the power source 3, and is detected by a detection resistance 1 which is connected between a power source supply terminal 14 of the negative feedback amplifier 13 and the power source 3.

An adder 15 generates a reference scanning selection voltage Vref by adding a voltage of a reference voltage source 211 and a correction signal 10 generated by a voltage correction circuit 6 to each other, and inputs the reference scanning selection voltage Vref to a positive-phase input terminal of the negative feedback amplifier 13.

Firstly, immediately after turning on a power source of the image display device, the image data 207 corresponding to a detection image pattern in full black or having particular gradations is inputted to the voltage correction circuit 6. Based on the image data 207, the voltage correction circuit 6 generates the correction signal 10 in the same manner as the embodiment 1. The adder 5 generates the reference scanning selection voltage Vref in response to the correction signal 10.

Next, the image display device assumes a usual state in which a moving image is displayed. When the scanning selection switch SH1 is selected in a first horizontal scanning period, the scanning selection switch SH1 and the feedback switch SF1 are turned on and a non-selection switch SL1 is turned off so that a scanning selection voltage is applied to the scanning electrode S1. Here, the scanning selection switch SH2 and the feedback switch SF2 are turned off and a non-selection switch SL2 is turned on so that a scanning non-selection voltage is applied to the scanning electrode S2.

In the next horizontal scanning period, the scanning selection switch SH2 and the feedback switch SF2 are turned on and the non-selection switch SL2 is turned off so that a selection voltage is applied to the scanning electrode S2. Here, the scanning selection switch SH1 and the feedback switch SF1 are turned off and the non-selection switch SL1 is turned on so that a scanning non-selection voltage is applied to the scanning electrode S1.

In each horizontal scanning period, the scanning selection voltage outputted to the scanning electrode becomes, due to a negative feedback operation, equal to the reference scanning selection voltage Vref inputted to the positive-phase input terminal of the negative feedback amplifier 13. Accordingly, even when a voltage drop is generated due to an ON resistance Ron of the scanning selection switch of the scanning electrode selection circuit 30 and an electric current which flows corresponding to the image data 207, the voltage applied to the scanning line is not changed.

Here, since a change with time of characteristic of electron sources is gentle, by merely generating the reference scanning selection voltage Vref immediately after turning on the power source of the image display device, it is possible to sufficiently prevent a change of an element current attributed to a change of a threshold voltage with time.

According to this embodiment, in a display which arranges the electron emitting elements thereon in a matrix array, even when the voltage drop is generated due to the ON resistance of the selection switch of the scanning electrode selection circuit and the electric current which flows corresponding to the image data, the scanning selection voltage assumes the predetermined reference voltage. That is, by detecting the scanning line current and by correcting the initial reference voltage, it is possible to prevent the generation of smear attributed to the voltage drop and, at the same time, it is also possible to ensure the element current corresponding to the image data even when the threshold voltage of the electron emitting element is changed with time thus preventing a change of brightness. Accordingly, this embodiment can provide an image display device of high reliability and high image quality.

### Embodiment 3

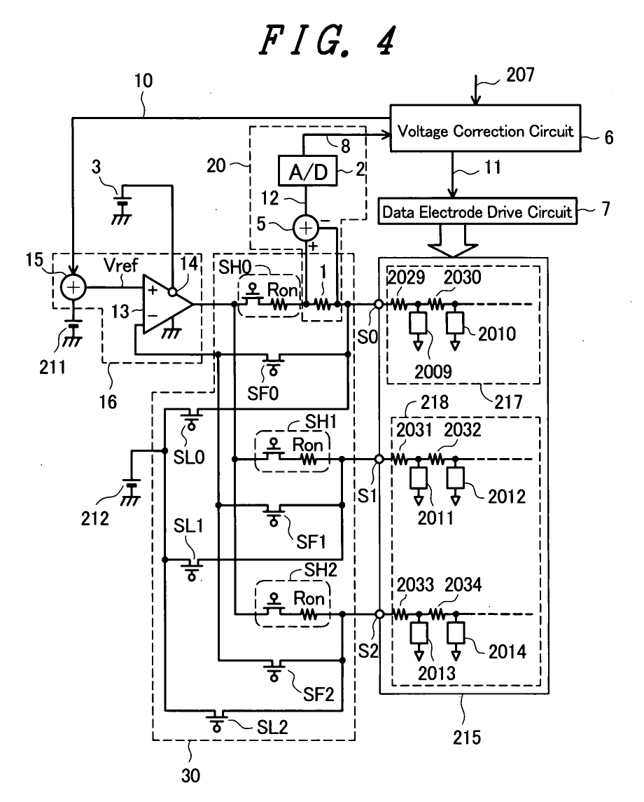

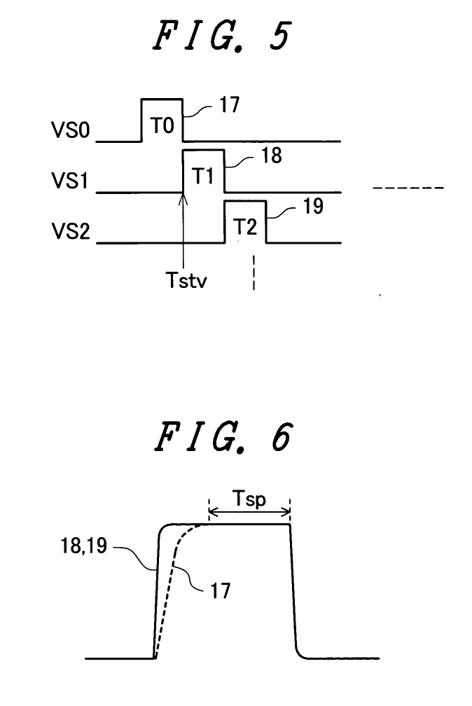

The explanation is made with respect to an image display device according to the embodiment 3 of the present invention in conjunction with FIG. 4, FIG. 5 and FIG. 6. FIG. 4 is a circuit constitutional view of the image display device of this embodiment, and FIG. 5 and FIG. 6 are operational waveform charts of the image display device of the embodiment shown in FIG. 4. In FIG. 4, parts having identical functions as the parts shown in FIG. 3 are given the same numerals.

In FIG. 4, in a display external region 217 of a display panel 215, for detecting an electric current which flows into a scanning line constituting the reference, a reference scanning electrode S0 and electron emitting elements 2009 and 2010 which are connected to crossing points between the scanning line constituting the reference and data lines are arranged.

The number of electron emitting elements which are connected to the scanning line constituting the reference is equal to the number of horizontal pixels in a display region 218. Further, between the reference scanning electrode S0 and a scanning selection switch SH0, a detection resistance 1 is arranged. Here, symbol SF0 indicates a feedback switch, and symbol SL0 indicates a non-selection switch. Other constitutions shown in FIG. 4 are equal to corresponding constitutions shown in FIG. 3.

Next, the manner of operation of the image display device of the embodiment 3 is explained. Firstly, during a horizontal scanning period T0 shown in FIG. 5, a drive pulse (VS0) 17 is applied to the reference scanning electrode S0 so as to drive the reference scanning electrode S0. Here, a vertical display period starts at a point of time Tstv shown in FIG. 5. A scanning electrode S1 is driven during a horizontal scanning period T1 in response to a drive pulse (VS1) 18. In response to a next drive pulse (VS2) 19, a scanning electrode S2 is driven during a horizontal scanning period T2. Thereafter, the line driving is performed sequentially.

For every vertical scanning period, the reference scanning electrode S0 is selected so that the detection of the scanning line current and the comparison calculation in a voltage correction circuit 6 are executed. Image data inputted for the detection of the scanning line current is changed for every two other vertical scanning periods.

During the first vertical scanning period, the image data 207 which allows the applied voltage applied to the electron emitting elements to assume the threshold voltage is inputted to the voltage correction circuit 6. The voltage correction circuit 6 detects the scanning line current at this point of time and corrects the reference voltage value which becomes the scanning selection voltage thus compensating for a change of a threshold voltage of the electron emitting elements.

During the subsequent second vertical scanning period, the image data 207 which allows the applied voltage applied to the electron emitting elements to assume a voltage other than the threshold voltage is inputted to the voltage correction circuit 6. The voltage correction circuit 6 detects the scanning line current at this point of time and corrects the data voltage thus compensating for a change of gradient of I-V characteristic of the electron emitting elements.

FIG. 6 is a detailed waveform chart of the drive pulse 17 applied to the reference scanning electrode S0 in the display external region 217 and the drive pulses 18 and 19 applied to the scanning electrodes in the display region 218. A rising speed of the drive pulse 17 applied to the reference scanning electrode S0 is determined based on a resistance which is a product obtained by adding a resistance value of the detection resistance 1 to the ON resistance Ron of the scanning selection switch SH0 and a capacitance which is connected to the scanning line. Accordingly, the detection of the scanning line current is performed in a period Tsp after the drive pulse 17 reaches a steady-state value.

On the other hand, rising speeds of the drive pulses 18 and 19 of the scanning electrodes S1 and S2 are determined based on the ON resistances Ron of the scanning selection switches and the capacitances which are connected to the scanning lines. Accordingly, there arises no delay in the rising of a scanning electrode drive waveform attributed to the detection resistance 1 in the display region 218 thus preventing the lowering of brightness relevant to the detection resistance 1.

This embodiment 3 can acquire advantageous effects substantially equal to the advantageous effects of the embodiment 1 and the embodiment 2. Further, the scanning line current is detected using the electron emitting element which is arranged outside the display region and hence, this embodiment 3 can also perform the detection of the scanning line current in a usual state in which a moving image is displayed whereby it is possible to perform the correction of either one or both of the scanning selection voltage and the data voltage which can follow not only the change with time of the threshold voltage or the gradient of the electron emitting elements but also a change of temperature of the electron emitting elements.

Further, there is no delay in waveform relevant to the detection resistance and hence, the lowering of brightness does not occur. Accordingly, it is possible to provide an image display device of high reliability and high image quality.

### Embodiment 4

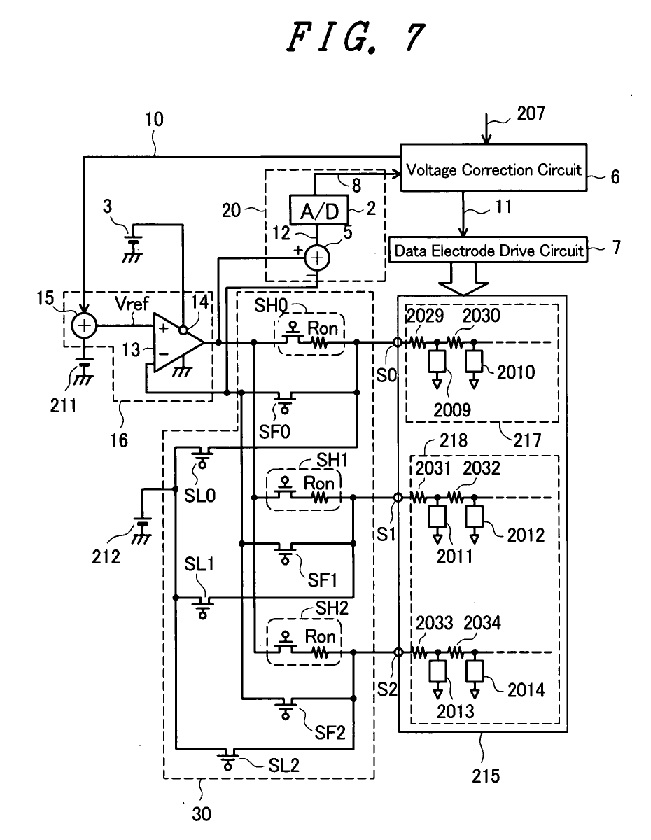

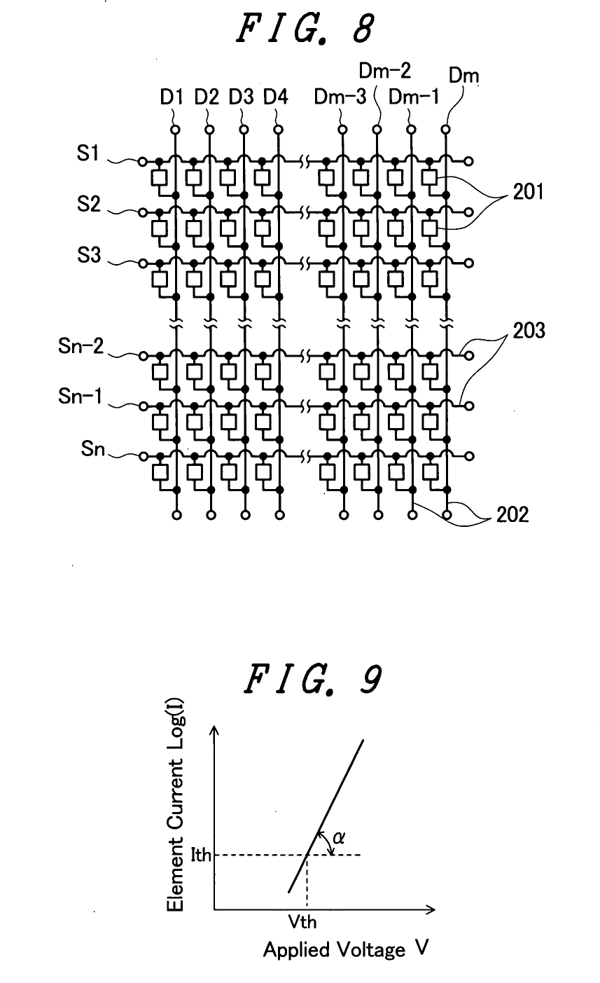

The explanation is made with respect to an image display device according to the embodiment 4 of the present invention in conjunction with FIG. 7. FIG. 7 is a circuit constitutional view of the image display device of this embodiment. In FIG. 7, parts having identical functions as the parts shown in FIG. 4 are given the same numerals.

In FIG. 7, a scanning line current is detected based on a voltage drop quantity of an ON resistance Ron of a scanning selection switch SH0. That is, by inputting an output voltage and an inverse-phase input voltage of a negative feedback amplifier 13 to an adder-subtracter 5, the adder-subtracter 5 outputs an output signal 12 proportional to a product of an ON resistance Ron of the scanning selection switch SH0 and a scanning line current. The output signal 12 is converted into digital current detection data 8 using an A/D converter 2 and the digital current detection data 8 is inputted to a voltage correction circuit 6.

In the same manner as the embodiment 3 explained in conjunction with FIG. 4, in a display external region 217 of a display panel 215, a scanning electrode S0, electron emitting elements 2009 and 2010 which are connected to a scanning line and data lines are arranged for detecting the scanning line current. The detection of a scanning line current and a comparison calculation in the voltage correction circuit 6 are executed for every vertical scanning period so as to compensate for changes with time of a threshold voltage and a gradient.

This embodiment 4 can acquire advantageous effects substantially equal to the advantageous effects of the embodiment 3 and, at the same time, a scanning line current detection circuit 20 requires no detection resistance 1. Accordingly, it is possible to provide an image display device of high reliability and high image quality at a low cost.

Here, this embodiment can, even when the display external region 217 is not provided, perform the detection and the correction of the scanning line current by inputting image data corresponding to a detection image pattern in full black or having particular gradations during a period from a point of time immediately after a power source is turned on to a point of time that the image display device assumes a usual display state.

In the embodiment 1 to the embodiment 4, even when the I-V characteristic of the electron emitting elements is changed with time, the changes of brightness and smear with time can be suppressed by adopting the element current corresponding to the image data. However, these embodiments cannot prevent a change of brightness when emission efficiency is changed with respect to the number of electrons emitted from the electron emitting element.

When the change of brightness attributed to the change of emission efficiency with time arises as a drawback, such a change of brightness can be overcome as follows. Firstly, by using any one of the embodiments 1 to 4, the changes of brightness and the deterioration of image quality by smear with time attributed to the I-V characteristic is suppressed. Thereafter, the emission current is detected in a high voltage circuit 220, for example, and an applied time in which the data voltage is applied to the electron emitting elements or an output voltage value of the high voltage circuit is corrected such that the emission current agrees with a predetermined reference value.

Further, in the embodiments 2 to 4, the voltage of the scanning electrode Si (i=1 to n) which becomes an output point of a scanning electrode selection circuit 30 is fed back so as to control a voltage inputted to a source of a transistor which constitutes a selection switch SH1 (i=1 to n) and hence, the scanning selection voltage is set to the predetermined reference voltage without based on the voltage drop of the selection switch. However, by controlling a voltage inputted to a gate of the transistor which constitutes the selection switch, it is possible to set the scanning selection voltage to the predetermined reference voltage without based on the voltage drop of the selection switch.

Further, in the embodiments 2 to 4, calculation parameters are generated based on the current detection data 8, data electrode drive data 11 is calculated based on the calculation parameters and the image data 207, and a data voltage is corrected such that voltage drops of respective parts of the scanning line which are determined corresponding to the image data 207 are compensated. Due to such an operation, even when the I-V characteristic of the electron emitting elements is changed with time, the voltage drop which occurs attributed to the scanning line resistance can be suppressed thus preventing the deterioration of image quality by smear.

### Embodiment 5

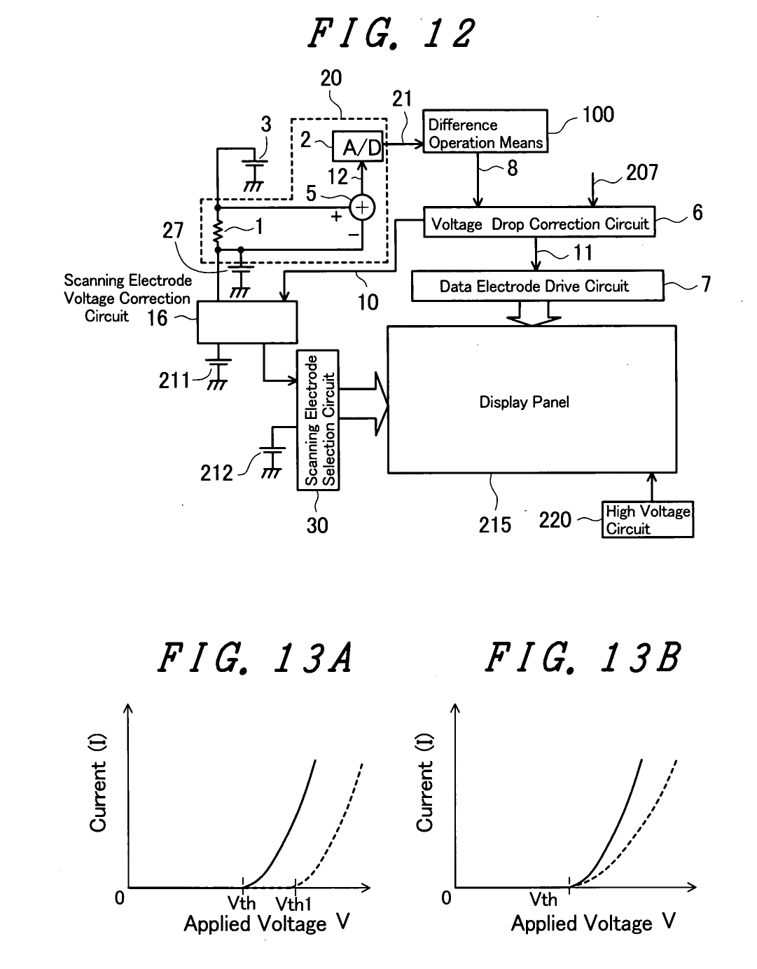

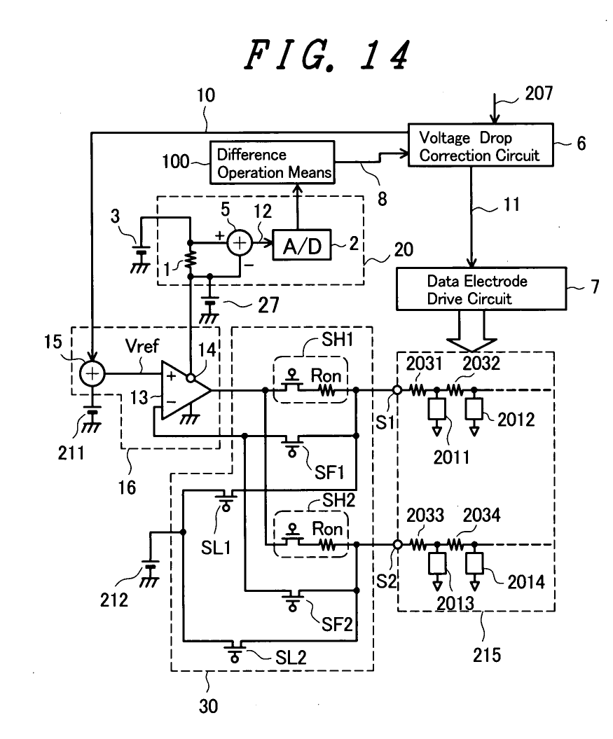

The explanation is made with respect to an image display device according to the present invention in conjunction with FIG. 12, FIG. 13A and FIG. 13B. FIG. 12 is a circuit constitutional view of the image display device of this embodiment. FIG. 13A and FIG. 13B are graphs for explaining a change-with-time of thin film electron emitting element characteristic.

In FIG. 12, parts having identical functions as the parts shown in FIG. 1 are given the same numerals. Capacitor 27 is removes the power supply ripple element.

Difference operation means 100 saves detection data 21 output from the analog to digital conversion machine 2, and inputs difference data 8 which operates the difference to voltage drop correction circuit 6. There is two kinds of detection data 21. Difference data 8 is data which operates the difference from two kinds of detection data. The detection data 21 contain a first current value and a second current value. The first current value is current value which flow to scanning wiring when image pattern of black or low gray scale is displayed in display panel 215. the second current value is current value which flow to the scanning wiring when the image pattern of other gray scale is displayed 215.

In this embodiment, voltage correction circuit 6 corrects voltage drop. Voltage correction circuit 6 generates correction signal 10 to correct the scanning electrode voltage which the scanning electrode voltage correction circuit 16 outputs based on difference data 8. Based on this correction signal 10, the scanning electrode voltage correction circuit 16 supplies the corrected scanning electrode voltage to scanning electrode select circuit 30.

Image data 207 is input to voltage drop correction circuit 6. Voltage drop correction circuit 6 operates the amount of voltage drop according to the scanning wiring resistance and the data wiring resistance. Data electrode drive data 11 is generated by using image data 207 and difference data 8 as an operation parameter when operating it, and the smear is controlled.

The current supplied from power supply 3 to scanning electrode voltage correction circuit 16 is current which added a scanning lines current Iscan and other currents (ex. bias current Ibias). Here, Rdet is resistance of detection resistance 20, Vdet is voltage of detection resistance 20. The expression (1) consists.

Vdet=Rdet(Iscan+Ibias) (1)

Detecting voltage Vdet1 in a black display and detecting voltage Vdet2 in a white display are shown by using expression (1) as next expression (2) and (3). Those differences are given by expression (4).

Vdet1=Rdet(Iscan1+Ibias) (2)

Vdet2=Rdet(Iscan2+Ibias) (3)

Vdet2−Vdet1=Rdet(Iscan2−Iscan1) (4)

In expression (4), Iscan1 is a scanning lines current in a black display, and Iscan1≈0.0. Therefore, it is possible to think expression (4) to be next expression (5).

Vdet2−Vdet1=Rdet*Iscan2 (4)

The right side of expression (5) is a product of scanning lines current Iscan2 in a white display and resistance Rdet of detection resistance 20. The detecting voltage proportional to the scanning lines current is obtained by the difference operation. That is, accurate scanning lines current can be detected by canceling the influence of the bias current of the scanning electrode voltage correction circuit 16.

The first factor is changing of Vth in the threshold voltage (FIG. 13A) into Vth1 where the electron source current begins to flow. The scanning electrode voltage, which scanning electrode voltage correction circuit 16 outputs, is corrected to such changing Vth by using correction signal 10.

The second factor, in the region where applied voltages are larger than Vth, is changes in the inclination by which the electron source current does not reach the specified value even if a prescribed voltage is impressed (FIG. 13 B). To the change in this inclination, the data electrode drive data 11, which voltage drop correction circuit 6 outputs, is corrected by using difference data 8. When two factors exist at the same time, the voltage of the scanning electrode and the data electrode voltage are corrected at the same time.

There is a method of obtaining the difference of the current at display of black and other gray scale image pattern. The scanning lines current value can be detected in high accuracy by difference operation means 100.

According to this embodiment, in a display which arranges the electron emitting elements thereon in a matrix array, Even if deteriorating with the passage of time occurs, the smear is not generated because the electron source characteristic can be detected in high accuracy. Accordingly, present invention can offer the image display device which have dependable and high resolution.

### Embodiment 6

The explanation is made with respect to an image display device according to the embodiment 6 of the present invention in conjunction with FIG. 14. FIG. 14 is a circuit constitutional view of the image display device of this embodiment. For facilitating the explanation of the circuit constitution, only two scanning lines and a circuit for driving the scanning lines are shown in the drawing.

In FIG. 14, parts having identical functions as the parts shown in FIG. 12 are given the same numerals. The scanning electrode selection circuit 30 monitor voltages of the scanning electrodes S1 and S2 by using feedback switches SF1 and SF2. The scanning electrode voltage correction circuit 16 is constituted of a negative feedback amplifier 13 and an adder 15. The voltage of the scanning electrode has been stabilized by the negative feedback operation. Moreover, the voltage of the scanning electrode S1 and S2 becomes same potential as voltage Vref of the non-inverter input terminal of negative-feedback amplifier 13 by this negative feedback operation. Display panel 215 is composed of each electron source 2011-2014 and scanning wiring resistance 2031-2034 of each pixel.

In this embodiment, it explains operation that a change with the lapse of time in the threshold voltage Vth shown in FIG. 13A is corrected.

When scanning-electrode S1 is selected in a first horizontal scanning period, the scanning selection switch SH1 and return switch SF1 is turned on, and the non selection switch SL1 is turned off. At this time, scanning selection switch SH2 which selects scanning electrode S2 and return switch SF2 are turned off, non-selection switch SL2 is turned on, scanning electrode S2 is fixed to non-selection voltage. As a result scanning electrode S2 is non-selection state.

In the next horizontal scanning period, the scanning selection switch SH2 and the feedback switch SF2 are turned on and the non-selection switch SL2 is turned off so that a selection voltage is applied to the scanning electrode S2. Here, the scanning selection switch SH1 and the feedback switch SF1 are turned off and the non-selection switch SL1 is turned on so that a scanning non-selection voltage is applied to the scanning electrode S1.

A scanning line current is supplied to the display panel 215 via a power source supply terminal 14 of the negative feedback amplifier 13, an output element in the inside of the negative feedback amplifier 13 and a scanning selection switch SH1, SH2 from the power source 3. Detection resistance 1 is positioned between negative feedback amplifier 13 and power supply 3, and connected to the power supply terminal 14 of the negative feedback amplifier 13 and the power supply 3. The power supply current of negative feedback amplifier 13 flows to detection resistance 1. That is, the scanning lines current is detected by detection resistance 1.

The potential of both terminals of detection resistance 1 is input to adder-subtracter 5. Adder-subtracter 5 outputs detection signal 12 proportional to the both ends potential difference of detection resistance 1. This detection signal 12 is converted into digital detection data 21 by using analog to digital conversion machine 2, and is inputted to the difference operation means 100. Difference operation means 100 operates the difference of the detection data when display the black image pattern and the other image. This difference data 8 is input to voltage drop correction circuit 6.

Voltage drop correction circuit 6 generates correction signal 10 which corrects the output voltage of correction circuit 16 of the voltage of the scanning electrode based on difference data 8. the reference scanning selection voltage Vref is generated by the addition of the voltage of the correction signal 10 and reference voltage source 211 with addition machine 15.

By inputting reference scanning electrode voltage to positive-phase input-terminal of the negative feedback amplifier 13, the negative feedback operates. The negative feedback is operation that the scanning electrode voltage become equal with Vref. As for operation by which the bias current of negative-feedback amplifier 13 is canceled, it is similar to expression (5) from expression (1) explains in example 5. The explanation is omitted.

As well as embodiment 5, this embodiment is possible to provide an image display device of high reliability and high image quality.

### Embodiment 7

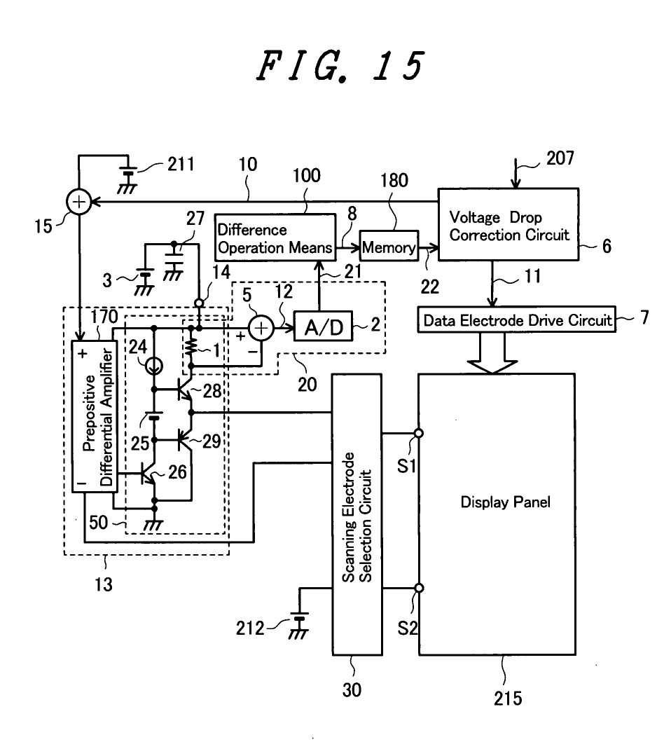

The explanation is made with respect to an image display device according to the embodiment 7 of the present invention in conjunction with FIG. 15. FIG. 15 is a circuit constitutional view of the image display device of this embodiment. Detection resistance 1 was installed in negative-feedback amplifier 13. In FIG. 15, parts having identical functions as the parts shown in FIG. 14 are given the same numerals. The negative feedback amplifier 13 include of prepositive differential amplifier 170 and output circuit 50 (detection resistance 1, transistor 26, 28, 29, source of current 24, and voltage source 25).

The bias current of output circuit 50 is decided depending on the bias voltage value in voltage source 25. The scanning lines current passes detection resistance 1 and transistor 28, and flows into scanning electrode S1 and S2 through scanning electrode select circuit 30.

The current of detection resistance 1 contains the bias current of scanning lines current and output circuit 50. In this case, a relation among the bias current, the scanning line current and the detecting voltage is same relation as expression (1)-(5) in embodiment 5. The influence of the bias current of output circuit 50 can be canceled.

In addition, because detection resistance 1 was installed between capacitor 27 and transistor 28, there is no delay of the amperometric response by the time constant formed by capacitor 27 connected within the power supply 3 and detection resistance 1, and the scanning lines current of each scanning lines can be detected.

Current detection circuit 40 detects the scanning lines current of each scanning lines, and makes detection data 21. The detection data 21 is operated by the difference operation means 100, and the difference data 8 is memorized in memory 180. Voltage drop correction circuit 6 reads difference data 8 of each scanning lines, and operates correction signal 10 and data electrode drive data 11 based on difference data 8.

This embodiment can optimize the correction amount of current of each scanning lines because the change in the electron source characteristic of each scanning lines can be detected as well as embodiment 5 and 6.

### Embodiment 7

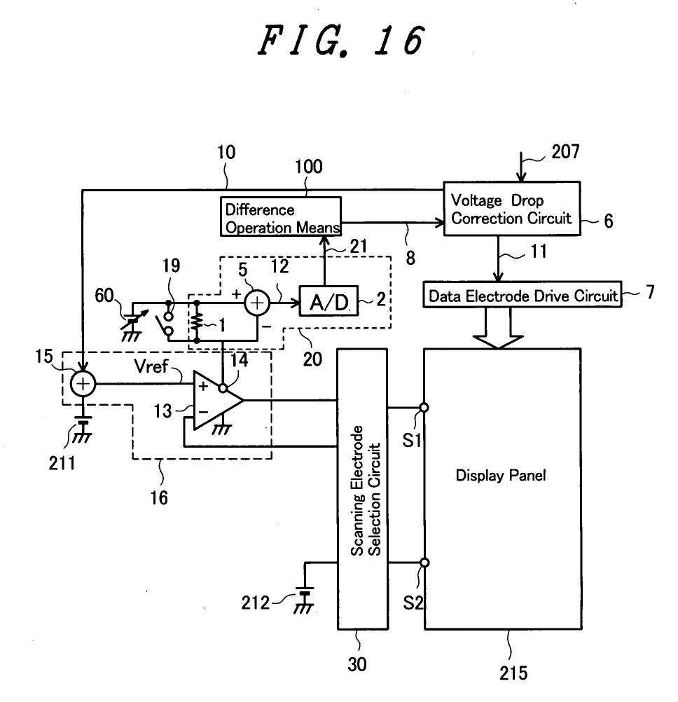

The explanation is made with respect to an image display device according to the embodiment 8 of the present invention in conjunction with FIG. 16. FIG. 16 is a circuit constitutional view of the image display device of this embodiment. Short circuiting means 19 (switching device) connects with detection resistance 100 in parallel, and the power supply to supply the current is voltage changeable type power supply 60. In FIG. 16, parts having identical functions as the parts shown in FIG. 14 are given the same numerals and the explanation is omitted.

The bias current of scanning lines current and negative feedback amplifier 16 flows to detection resistance 1. Therefore, when detecting the scanning current as explained by the above mentioned embodiments, voltage drop Vdet which is product of the resistance of detection resistance 1 and the flowing current is generated. As for operation by which the bias current of negative-feedback amplifier 13 is canceled, it is similar to expression (5) from expression (1) explains in example 5.

Voltage drop Vdet by detection resistance 1 decreases the power output dynamic range of negative-feedback amplifier 13, and saturates the negative-feedback amplifier 13. Then, the voltage value of voltage changeable type power supply 60 is set to high voltage value Vdd1 when detection operates, and switching device 20 is turned off. The voltage value of voltage changeable type power supply 60 is set to lower voltage value Vdd2 than Vdd1 when the normal operation of no detection, and the switching device 19 is turned on.

A necessary power supply voltage for the normal operation is set to Vdd2. Vdd1 is decided according to resistance of detection resistance 1 and maximum current value which flows thereof. A useless power loss can be suppressed by switching the power supply voltage when detection operation period and usually operation period.

This embodiment can obtain the same effect as embodiment 5. In addition, Because the power supply voltage when detection operates and the power supply voltage when normal operates are changed, the power supply voltage can be set best by each operation mode. Therefore, the structure in this embodiment can suppress a useless power loss. This invention can offer the image device which provided high resolution, low power consumption and dependable.

### Embodiment 9

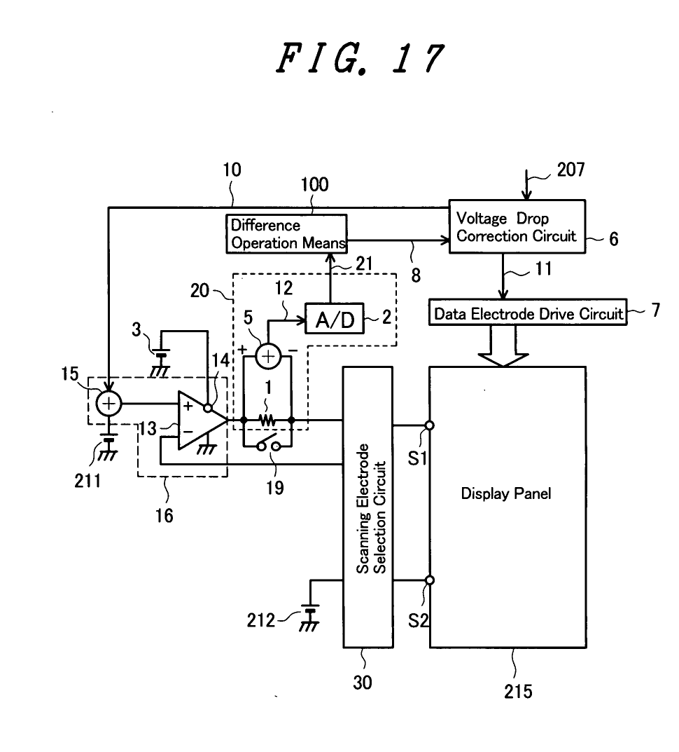

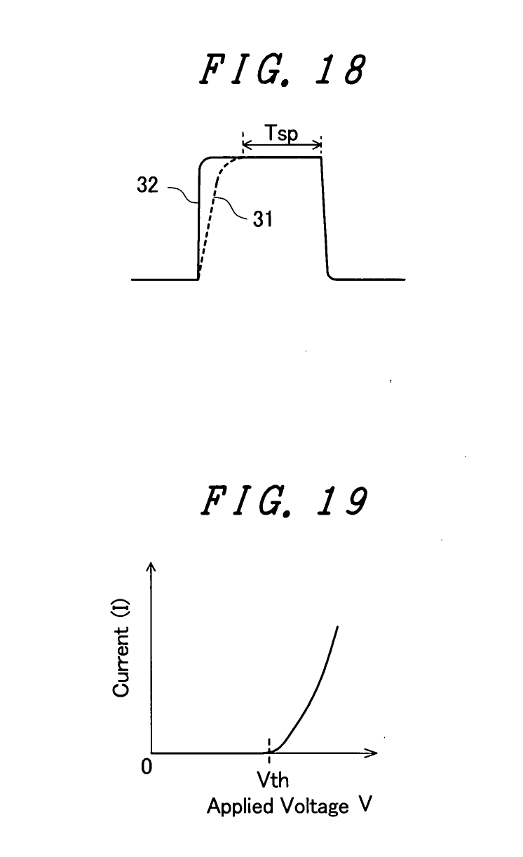

The explanation is made with respect to an image display device according to the present invention in conjunction with FIG. 17 and FIG. 18. FIG. 17 is a circuit constitutional view of the image display device of this embodiment. The detection resistance 1 is installed between the data output side of negative feedback amplifier 13 and the data input side of scanning electrode select circuit 30. In FIG. 17, parts having identical functions as the parts shown in FIG. 12-15 are given the same numerals. FIG. 18 is operational waveform charts of the image display device of the embodiment shown in FIG. 17, and is a horizontal scanning periodic waveform of the scanning electrode drive voltage.

In FIG. 17, the current which flows in detection resistance 1 is only the scanning line current. When the detection of the scanning line current operates, switching device 19 is off, and when the detection means of the scanning line current does not operate (so called normal operation), switching device 19 is on.

When detection operates, scanning electrode drive waveform 31 shown in FIG. 18 stands up based on the time constant. The time constant is decided according to the electron source capacity connected with one of the scanning line, the resistance Rdet of detection resistance 1 and the on-resistance Ron of the scanning selection switch in scanning electrode select circuit 30 shown in FIG. 14. On the other hand, the driving waveform 32 stands up steep when time constant lower than time constant at detection operates. The sampling timing of analog to digital conversion machine 2 in the detection operation is a period Tsp when the scanning electrode drive waveform becomes a stationary state. The scanning lines current can be detected stabilizing if it is this period Tsp. Therefore, the delay of driving wave when detection operates does not become a problem.

At the normal operation, The rise delay of the scanning electrode drive wave is a cause by which the brightness decrease is caused. The rise time of driving wave is made steep by turning on switching device 19.

According to this embodiment as well as embodiment 6, in a display which arranges the electron emitting elements thereon in a matrix array, even if the electron source characteristic is deteriorated because of a change with the lapse of time of the display panel, the smear is not generated. In addition, the structure of this embodiment can prevent the brightness decrease by suppressing driving wave delay. Therefore, this invention can offer the display device which is dependable and high resolution.

What is claimed is:

1. An image display device comprising:
a display panel having a back substrate which includes a plurality of scanning lines parallel to each other, a plurality of data lines which is orthogonal to the scanning lines and a plurality of electron emitting elements which is connected to crossing points between the scanning lines and the data lines and a face substrate having phosphors which emit light due to electrons emitted from the electron emitting elements;
a scanning electrode selection means which is connected to the scanning lines;
a data electrode drive means which is connected to the data lines; and
a high voltage means which radiates emission electrons emitted from the electron emitting elements to the phosphors after accelerating the emission electrons, wherein
the image display device further includes a scanning line current detection means which detects a scanning line current flowing into the scanning lines from the scanning electrode selection means, and a scanning electrode voltage correction means which corrects the scanning line selection voltage which the scanning electrode selection means outputs based on a detection result of the scanning line current detection means such that the scanning line current assumes a predetermined value.

2. An image display device according to claim 1, wherein the back substrate includes the scanning line which is arranged on at least one side thereof outside a display region thereof and a plurality of electron emitting elements which is connected between the scanning line and the data line, and the scanning line current detection means detects an electric current which flows into the scanning line.

3. An image display device according to claim 1, wherein the scanning line current detection means detects the scanning line current during a period immediately after a power source is turned on.

4. An image display device comprising:
a display panel having a back substrate which includes a plurality of scanning lines parallel to each other, a plurality of data lines which is orthogonal to the scanning lines and a plurality of electron emitting elements which is connected to crossing points between the scanning lines and the data lines and a face substrate having phosphors which emit light due to electrons emitted from the electron emitting elements;
a scanning electrode selection means which is connected to the scanning lines;
a data electrode drive means which is connected to the data lines; and
a high voltage means which radiates emission electrons emitted from the electron emitting elements to the phosphors after accelerating the emission electrons, wherein
the image display device further includes a scanning line current detection means which detects a scanning line current flowing into the scanning lines from the scanning electrode selection means, and a voltage correction means which corrects a data voltage which the data electrode selection means outputs based on a detection result of the scanning line current detection means such that an electric current which flows into the electron emitting elements corresponds to image data.

5. An image display device according to claim 4, wherein the back substrate includes the scanning line which is arranged on at least one side thereof outside a display region thereof and a plurality of electron emitting elements which is connected between the scanning line and the data line, and the scanning line current detection means detects an electric current which flows into the scanning line.

6. An image display device according to claim 4, wherein the scanning line current detection means detects the scanning line current during a period immediately after a power source is turned on.

7. An image display device comprising:
a display panel having a back substrate which includes a plurality of scanning lines parallel to each other, a plurality of data lines which is orthogonal to the scanning lines and a plurality of electron emitting elements which is connected to crossing points between the scanning lines and the data lines and a face substrate having phosphors which emit light due to electrons emitted from the electron emitting elements;
a scanning electrode selection means which is connected to the scanning lines;
voltage drop correction means which operates the influence of voltage drop by the current that flows to scanning wiring and data wiring and the resistance,
a data electrode drive means which is connected to the data lines; and
a high voltage means which radiates emission electrons emitted from the electron emitting elements to the phosphors after accelerating the emission electrons, wherein
a current detection means to detect which a first current value flowing to scanning wiring when image pattern of black or low gray scale is displayed in display panel and a second current value flowing to the scanning wiring when the image pattern of other gray scale is displayed,
an difference operation means 100 which operate the difference as for the first current value and the second current value,
the voltage drop correction means controls the scanning electrode voltage correction means or the data electrode driving means based on the difference operation result.

8. An image display device according to claim 7, wherein the current detection means detect a power source current of the scanning electrode voltage correction means.

9. An image display device according to claim 7, wherein the current detection means is series connected with the power output means of the scanning electrode voltage correction means and detect a current,
the current detection means detects the current which flows to the power output means.

10. An image display device according to claim 7, wherein the current detection means is arranged the scanning electrode voltage correction means and a scanning electrode selection means,
the current detection means detects the output current of the scanning electrode voltage correction means.

11. An image display device according to claim 7, wherein a short circuit means is arranged in parallel to the current detection means
the short circuit means state of opening when the current detect, and state of shorting when the current detect is not done.
